(19) United States
(12) Patent Application Publication
(10) Pub. No.: US 2019/0156512 A1
(43) Pub. Date: May 23, 2019

(54) ESTIMATION METHOD, ESTIMATION APPARATUS, AND NON-TRANSITORY COMPUTER-READABLE STORAGE MEDIUM

(71) Applicant: FUJITSU LIMITED, Kawasaki-shi (JP)

(72) Inventors: Tetsuhiro KATO, Yokohama (JP); Osafumi NAKAYAMA, Kawasaki (JP)

(73) Assignee: FUJITSU LIMITED, Kawasaki-shi (JP)

(21) Appl. No.: 16/190,389

(22) Filed: Nov. 14, 2018

(30) Foreign Application Priority Data
Nov. 22, 2017 (JP) 2017-224539

(51) Int. Cl. G06T 7/73; G06T 7/12; G06T 7/77

(52) U.S. Cl. CPC G06T 7/73; G06T 7/12; G06T 2207/30244; G06T 2207/10016; G06T 7/77

(57) ABSTRACT

A method for estimating orientation includes: executing a detection process that includes detecting multiple line segments from each of multiple images included in a video image captured by an imaging device; executing an estimation process that includes estimating a first inclination that is an inclination of a line segment that is among the multiple line segments and detected from a central region including a center of an image among the multiple images; and associating the first inclination with a vertical direction in a three-dimensional space to estimate an orientation of the imaging device.

### CROSS-REFERENCE TO RELATED APPLICATION

This application is based upon and claims the benefit of priority of the prior Japanese Patent Application No. 2017-224539, filed on Nov. 22, 2017, the entire contents of which are incorporated herein by reference.

### FIELD

The embodiment discussed herein is related to an estimation method, an estimation apparatus, and a non-transitory computer-readable storage medium.

### BACKGROUND

As driving recorders for automatically recording video images upon dangerous driving, various types of devices from a device attached by a trained dealer's worker to a vehicle in a special working space to a low-price device easily attached by a user have been widely used. In addition, differentiation of product values has been promoted by not only recording a video image during a movement of a vehicle but also adding a safety and security function, which is lane departure warning (LDW) using a video image and is aimed to reduce the number of traffic accidents.

To enable high-accuracy LDW, it is desirable to accurately detect a relative position and orientation of an attached in-vehicle camera with respect to a vehicle and accurately recognize the state of the vehicle during a movement of the vehicle. The position and orientation of the attached in-vehicle camera may be manually calibrated using a dedicated marker in a dedicated work space or may be automatically calibrated using a video image captured during a movement of the vehicle. However, since the work of calibrating the positions and orientation of a large number of distributed attached in-vehicle cameras one by one is hard and is not realistic, it is desirable to execute automatic calibration using a video image captured during a movement of a vehicle.

A technique for estimating a roll angle of an imaging device from a video image captured by the imaging device attached to a vehicle is known (refer to, for example, Japanese Laid-open Patent Publication No. 2016-111585 and Japanese Laid-open Patent Publication No. 2015-58915.

### SUMMARY

According to an aspect of the embodiments, a method for estimating orientation includes: executing a detection process that includes detecting multiple line segments from each of multiple images included in a video image captured by an imaging device; executing an estimation process that includes estimating a first inclination that is an inclination of a line segment that is among the multiple line segments and detected from a central region including a center of an image among the multiple images; and associating the first inclination with a vertical direction in a three-dimensional space to estimate an orientation of the imaging device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an imaging device attached to an vehicle;

FIGS. 2A and 2B are diagrams illustrating relationships between a roll angle of the imaging device and images;

FIG. 3 is a diagram illustrating an image including inclined line segments;

FIG. 4 is a diagram illustrating relationships between a world coordinate system and a camera coordinate system;

FIG. 5 is a diagram illustrating a functional configuration of a first estimation system;

FIG. 6 is a diagram illustrating a number M of regions within an image;

FIG. 7 is a flowchart of a first estimation process;

FIG. 8 is a diagram illustrating an image that does not include a line segment in a central portion of the image;

FIG. 9 is a diagram illustrating an image including a large number of line segments in each of edge portions of the image;

FIG. 10 is a diagram illustrating relationships between the positions and inclinations of line segments within an image;

FIG. 11 is a diagram illustrating a functional configuration of a second estimation system;

FIG. 12 is a flowchart of a second estimation process; and

FIG. 13 is a diagram illustrating a configuration of an information processing device.

### DESCRIPTION OF EMBODIMENTS

In the case where straight lines are detected from a video image captured by an in-vehicle camera, and a roll angle of the in-vehicle camera is estimated based on the inclinations of the detected straight lines, the accuracy of the estimation of the roll angle may be reduced.

This problem may occur in not only the case where LDW is executed but also the case where other image processing is executed based on the orientation of a moving imaging device.

According to an aspect of the present disclosure, a technique for improving the accuracy of estimating the orientation of an imaging device from a video image captured by the moving imaging device is provided.

Hereinafter, an embodiment is described in detail with reference to the accompanying drawings.

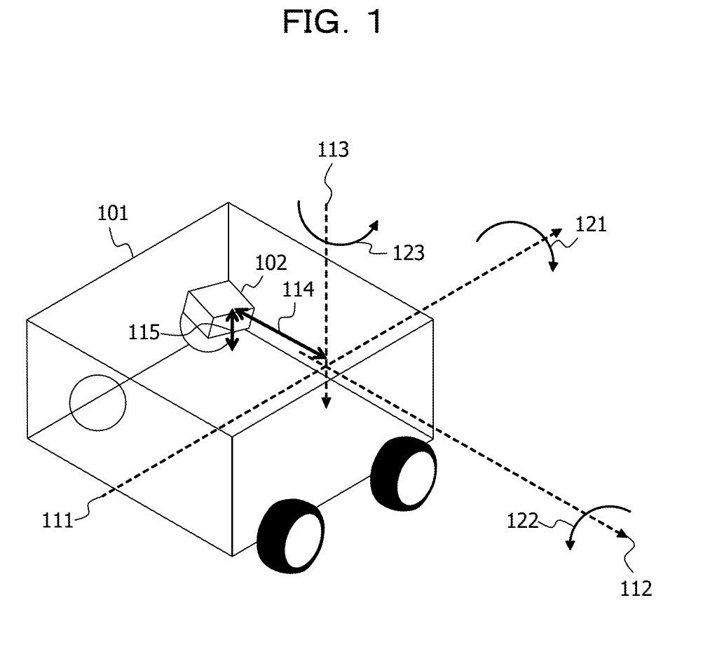

FIG. 1 illustrates an example of an imaging device attached to a vehicle. In this example, an imaging device 102 is attached to a front surface of a vehicle 101. As the imaging device 102, a camera with an imaging element such as a charged-coupled device (CCD) or a complementary metal-oxide-semiconductor (CMOS) may be used. In this case, a relative position of the attached imaging device 102 to the vehicle 101 may be expressed using a distance 114 (horizontal offset) in a horizontal direction between a central line 111 of the vehicle 101 in a front-back direction of the vehicle 101 and the imaging device 102, and a height 115 from a bottom surface of the vehicle 101 to the imaging device 102.

In addition, the orientation of the imaging device 102 with respect to the vehicle 101 may be expressed using a roll angle 121, a pitch angle 122, and a yaw angle 123. The roll angle 121 is a rotation angle about the central line 111. The pitch angle 122 is a rotation angle about a straight line 112 perpendicular to the central line 111 and extending in the horizontal direction. The yaw angle 123 is a rotation angle about a straight line 113 perpendicular to the central line 111 and the straight line 112 and extending in a vertical direction.

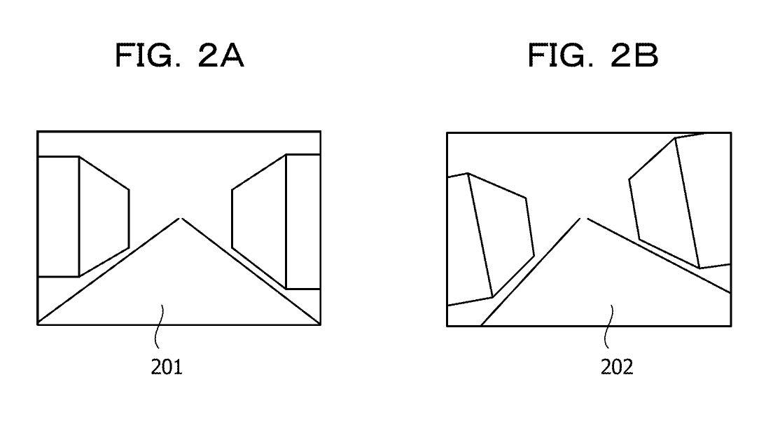

FIGS. 2A and 2B illustrate examples of relationships, described in Japanese Laid-open Patent Publication No. 2016-111585, between a roll angle of an imaging device and an image. FIG. 2A illustrates an example of an image captured in a state in which the roll angle of the imaging device is 0 degrees. When the roll angle is 0 degrees, a road surface 201 included in the image is formed in a bilaterally symmetric shape.

FIG. 2B illustrates an example of an image captured in a state in which the roll angle of the imaging device exists. When the roll angle of the imaging device exists, a road surface 202 included in the image is formed in a bilaterally asymmetric shape.

An image processing device described in Japanese Laid-open Patent Publication No. 2016-111585 treats a straight line (vertical straight line) extending in a vertical direction in a real world as a line inclined at a certain angle regardless of the position of the line within an image in a state in which the roll angle exists, as illustrated in FIG. 2B. Then, the image processing device estimates the roll angle based on a representative inclination of a straight line observed from a video image captured during a movement of the vehicle.

However, the premise that “a vertical straight line is inclined at a certain angle regardless of the position of the line within an image” is established only when a pitch angle is 0 degrees. When the roll angle and the pitch angle exist, the inclination of the vertical straight line varies depending on the position of the line within the image.

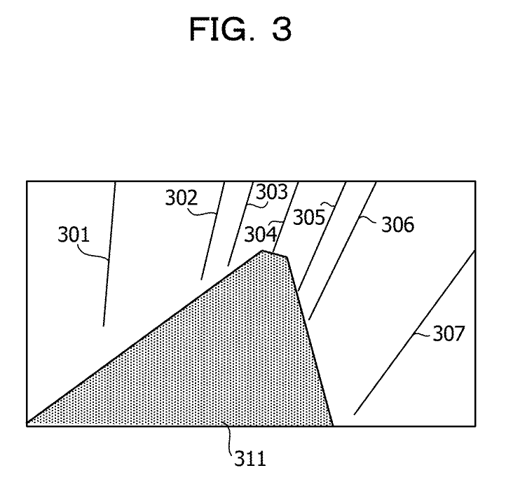

FIG. 3 illustrates an example of an image including line segments inclined at angles varying depending on the positions of the line segments. Line segments 301 to 307 included in the image are straight lines perpendicular to a road surface 311 in a real world three-dimensional space. However, when a roll angle and a pitch angle exist, the inclinations of the line segments vary depending on the positions of the line segments within the image. The inclination of a vertical straight line within an image is considered below using equations.

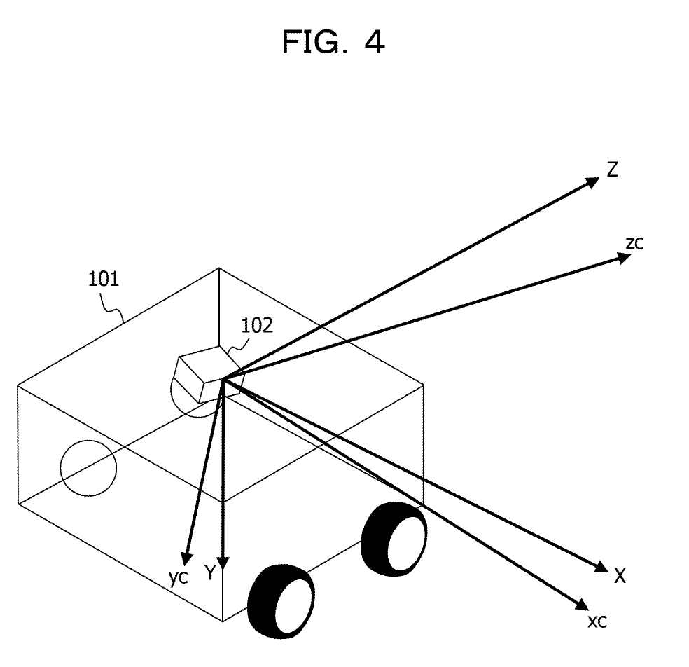

FIG. 4 illustrates an example of relationships between a world coordinate system and a camera coordinate system in a real world. In the world coordinate system expressed by X, Y, and Z axes in FIG. 4, the position of the imaging device 102 attached to the vehicle 101 is used as the original point. In the camera coordinate system expressed by an xc axis, a yc axis, and a zc axis in FIG. 4, the position of the imaging device 102 attached to the vehicle 101 is used as the original point. In the camera coordinate system, a pitch angle p, a roll angle r, and a yaw angle y are expressed with respect to the world coordinate system. The conversion of world coordinates (X, Y, Z) of a point in a three-dimensional space to camera coordinates (xc, yc, and zc) is expressed according to the following equations.

$$\begin{matrix}( \begin{matrix}xc \\ yc \\ zc\end{matrix} ) = ( \begin{matrix}cr & - sr & 0 \\ sr & cr & 0 \\ 0 & 0 & 1\end{matrix} ) ( \begin{matrix}1 & 0 & 0 \\ 0 & cp & - sp \\ 0 & sp & cp\end{matrix} ) ( \begin{matrix}cy & 0 & sy \\ 0 & 1 & 0 \\ - sy & 0 & cy\end{matrix} ) ( \begin{matrix}X \\ Y \\ Z\end{matrix} ) & ( 1 ) \\ cr = cos ( r ) & ( 2 ) \\ sr = sin ( r ) & ( 3 ) \\ cp = cos ( p ) & ( 4 ) \\ sp = sin ( p ) & ( 5 ) \\ cy = cos ( y ) & ( 6 ) \\ sy = sin ( y ) & ( 7 )\end{matrix}$$

When a point expressed by camera coordinates (xc, yc, zc) is observed from the imaging device 102, image coordinates (px, py) in an image plane are expressed according to the following equations.

$$\begin{matrix}px = fx ⋆ \frac{A ⋆ X + B ⋆ Y + C ⋆ Z}{G ⋆ X + H ⋆ Y + I ⋆ Z} & ( 11 ) \\ py = fy ⋆ \frac{D ⋆ X + E ⋆ Y + F ⋆ Z}{G ⋆ X + H ⋆ Y + I ⋆ Z} & ( 12 ) \\ A = cr ⋆ cy - sr ⋆ sp ⋆ sy & ( 13 ) \\ B = - sr ⋆ cp & ( 14 ) \\ C = cr ⋆ sy + sr ⋆ sp ⋆ cy & ( 15 ) \\ D = sr ⋆ cy + cr ⋆ sp ⋆ sy & ( 16 ) \\ E = cr ⋆ cp & ( 17 ) \\ F = sr ⋆ sy - cr ⋆ sp ⋆ cy & ( 18 ) \\ G = - cp ⋆ sy & ( 19 ) \\ H = sp & ( 20 ) \\ I = cp ⋆ cy & ( 21 )\end{matrix}$$

fx included in Equation (11) indicates a focal length expressed in units of pixel sizes in the horizontal direction. fy included in Equation (12) indicates a focal length expressed in units of pixel sizes in the vertical direction. Thus, units of fx and fy are pixels.

The yaw angle y is a rotation angle about the Y axis illustrated in FIG. 4 and does not affect the inclination of a vertical straight line included in an image and to be considered. For simplicity, the following description assumes that the yaw angle y is 0 degrees, and the inclination T of a vertical straight line included in the image and extending through a point P1 (X1, Y1, Z1) and a point P2 (X1, Y2, Z1) in a real world three-dimensional space is calculated.

When the pitch angle p is 0 degrees, image coordinates (px1, py1) of the point P1 and image coordinates (px2, py2) of the point P2 are expressed according to the following equations based on Equations (11) and (12).

px1=fx*(cr*X1−sr*Y1) (31)

py1=fy*(sr*X1+cr*Y1) (32)

px2=fx*(cr*X1−sr*Y2) (33)

py2=fy*(sr*X1+cr*Y2) (34)

The inclination T is calculated according to the following equation using Equations (31) to (34).

$$\begin{matrix}\begin{matrix}T = \frac{py 2 - py 1}{px 2 - px 1} \\ = \frac{fy ⋆ ( sr ⋆ X 1 + cr ⋆ Y 2 ) - fy ⋆ ( sr ⋆ X 1 + cr ⋆ Y 1 )}{fx ⋆ ( cr ⋆ X 1 - sr ⋆ Y 2 ) - fx ⋆ ( cr ⋆ X 1 - sr ⋆ Y 1 )} \\ = \frac{fy ⋆ sr ⋆ ( X 1 - X 1 ) + fy ⋆ cr ⋆ ( Y 2 - Y 1 )}{fx ⋆ cr ⋆ ( X 1 - X 1 ) - fx ⋆ sr ⋆ ( Y 2 - Y 1 )} \\ = \frac{fy ⋆ cr ⋆ ( Y 2 - Y 1 )}{- fx ⋆ sr ⋆ ( Y 2 - Y 1 )} \\ = - \frac{fy ⋆ cr}{fx ⋆ sr}\end{matrix} & ( 35 )\end{matrix}$$

The inclination T is expressed by Equation (35) using only fixed numbers fx, fy, cr, and sr regardless of the coordinates of the points P1 and P2. Thus, when the pitch angle p is 0 degrees, the inclination T of the vertical straight line is fixed regardless of the position of the line within the image.

When the pitch angle p exists, the image coordinates (px1, py1) are functions using X1, Y1, and Z1 as variables based on Equations (11) to (21), and the image coordinates (px2, py2) are functions using X1, Y2, and Z1 as variables based on Equations (11) to (21). Thus, since the inclination T varies depending on the coordinates of the points P1 and P2, the inclination T varies depending on the position of the line within the image.

As an example, the inclination T when the pitch angle p and the roll angle r are 20 degrees is calculated. In this case, an inclination T of a vertical straight line extending through a point (−5000, 1500, 10000) and a point (−5000, −1500, 10000) in the three-dimensional space in the image is −5.51*(fy/fx) based on Equations (11) to (21). In addition, an inclination T of a vertical straight line extending through the point (5000, 1500, 10000) and a point (5000, −1500, 10000) is −1.75*(fy/fx). It is apparent that, when the roll angle r and the pitch angle p exist, the inclination T of the vertical straight line varies depending on the position of the line within the image.

Thus, in an estimation method described in Japanese Laid-open Patent Publication No. 2016-111585 based on the premise that “a vertical straight line is inclined at a certain angle regardless of the position of the line within an image”, it is difficult to accurately estimate the roll angle r of the imaging device 102.

However, even when the roll angle r and the pitch angle p exist, the inclination T of the vertical straight line observed in a central portion of the image is not affected by the pitch angle p and determined based on the roll angle r. The vertical straight line observed in the central portion of the image extends through a point (0, Y1, Z1) and a point (0, Y2, Z1) in the three-dimensional space. The inclination T of the vertical straight line is calculated according to the following equation using Equations (11) to (21).

$$\begin{matrix}\begin{matrix}T = \frac{fy ⋆ \frac{F ⋆ Z 1 + E ⋆ Y 2}{I ⋆ Z 1 + H ⋆ Y 2} - fy ⋆ \frac{F ⋆ Z 1 + E ⋆ Y 1}{I ⋆ Z 1 + H ⋆ Y 1}}{fx ⋆ \frac{C ⋆ Z 1 + B ⋆ Y 2}{I ⋆ Z 1 + H ⋆ Y 2} - fx ⋆ \frac{C ⋆ Z 1 + B ⋆ Y 1}{I ⋆ Z 1 + H ⋆ Y 1}} \\ = \frac{fy}{fx} ⋆ \frac{\frac{F ⋆ Z 1 + E ⋆ Y 2}{I ⋆ Z 1 + H ⋆ Y 2} - \frac{F ⋆ Z 1 + E ⋆ Y 1}{I ⋆ Z 1 + H ⋆ Y 1}}{\frac{C ⋆ Z 1 + B ⋆ Y 2}{I ⋆ Z 1 + H ⋆ Y 2} - \frac{C ⋆ Z 1 + B ⋆ Y 1}{I ⋆ Z 1 + H ⋆ Y 1}} \\ = \frac{fy ⋆ cr}{fx ⋆ sr}\end{matrix} & ( 36 )\end{matrix}$$

The inclination T is expressed by Equation (36) using only fx, fy, cr, and sr regardless of the coordinates of the points P1 and P2, similarly to the inclination T expressed by Equation (35). fx and fy are fixed numbers. Thus, it is apparent that, even when the pitch angle p exists, the inclination T of the vertical straight line observed in the central portion of the image is determined based on only the roll angle r. In the embodiment, attention is paid to this feature, and a roll angle r may be estimated using a vertical straight line observed in a central portion of an image.

An estimating device according to the embodiment includes a storage unit, a detector, and an estimator. The storage unit stores a video image captured by an imaging device. The detector detects multiple line segments from each of multiple images included in the video image, and the estimator estimates the inclination of a line segment that is among the detected line segments and exists in a central region including the center of each of the images. The orientation of the imaging device is estimated by associating the estimated line segment with a vertical direction in a three-dimensional space.

According to the estimating device, the accuracy of estimating the orientation of the imaging device from a video image captured by the moving imaging device may be improved.

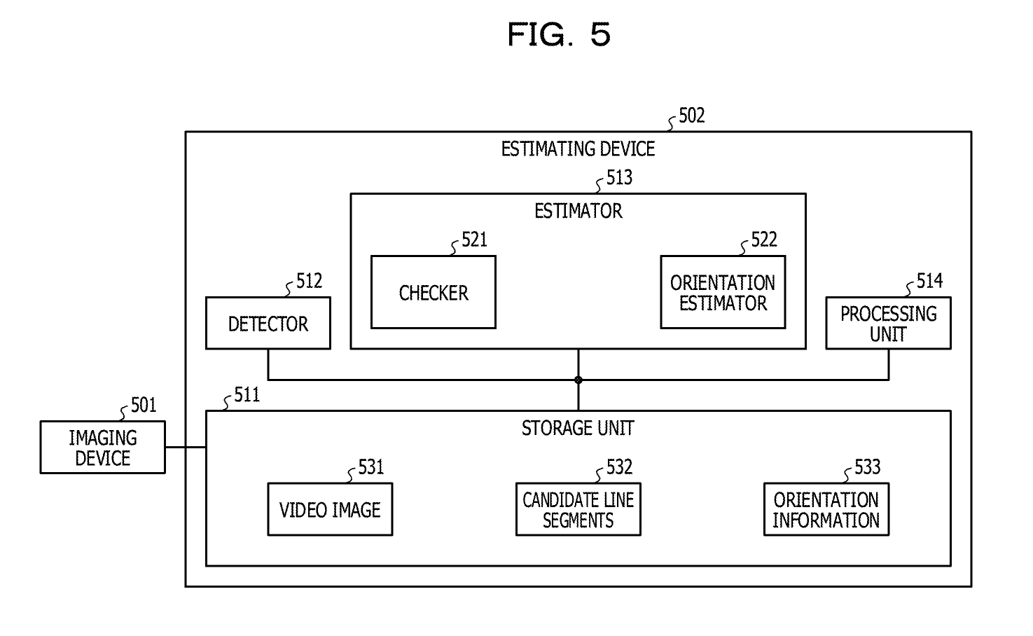

FIG. 5 illustrates an example of a functional configuration of a first estimation system including the estimating device according to the embodiment. An estimation system illustrated in FIG. 5 is, for example, attached to a vehicle and includes an imaging device 501 and an estimating device 502. The estimating device 502 includes a storage unit 511, a detector 512, an estimator 513, and a processing unit 514. The estimator 513 includes a checker 521 and an orientation estimator 522.

The imaging device 501 corresponds to the imaging device 102 illustrated in FIG. 1. The imaging device 501 captures a video image 531 of the vehicle in a movement direction of the vehicle during the movement of the vehicle or in a forward direction of the vehicle during the stop of the vehicle and outputs the captured video image 531 to the estimating device 502. The estimating device 502 stores the video image 531 output by the imaging device 501 in the storage unit 511. The video image 531 includes chronological multiple images. The multiple images captured at time points are also referred to as frames.

The detector 512 detects line segments from the images captured at the time points and included in the video image 531 and causes the detected line segments as candidate line segments 532 in the storage unit 511. For example, the detector 512 may detect the line segments from the images using filter processing that is one type of line segment detection algorithms and is Sobel filter, Canny's method, or the like. Each of the candidate line segments 532 is a candidate of a line segment corresponding to a vertical straight line in a three-dimensional space in an image. If a road surface extends in a horizontal direction, the vertical straight line is perpendicular to the road surface.

The storage unit 511 may store the line segments detected by the detectors 512 and associated with regions that are included in the images and from which the line segments have been detected. For example, when each of the images is divided into a number M (M is an odd number of 3 or more) of regions in the horizontal direction, the detector 512 associates each of the line segments with any of the regions and causes the line segments to be stored in the storage unit 511.

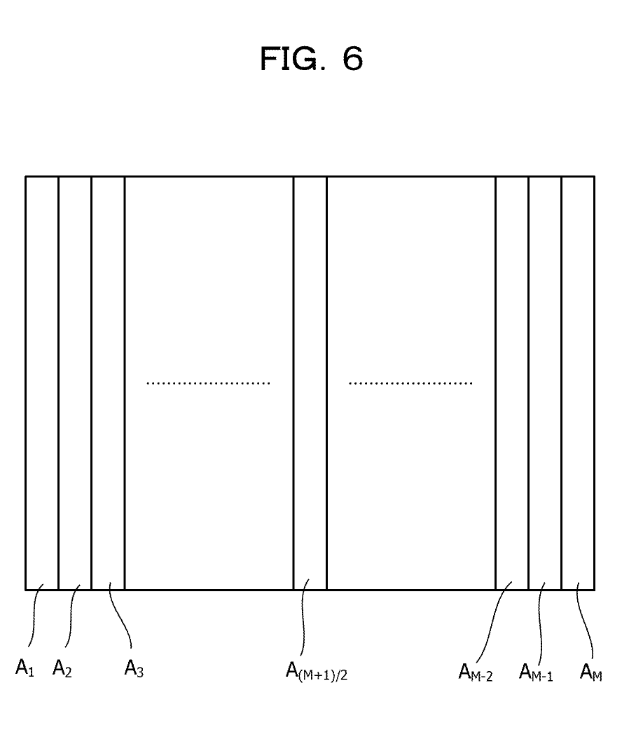

FIG. 6 illustrates an example of a number M of regions within an image. The image illustrated in FIG. 6 is divided into vertically long regions A₁ to A_{M}. The number M of regions may be determined based on an angle of view of the imaging device 501, the resolution of the imaging device 501, and the like. For example, M is an odd number in a range of 21 to 31.

In this case, the detector 512 executes a labeling process on the detected line segments, associates the line segments with regions Ai (i=1 to M) to which lower ends of the line segments belong, and records the detected line segments. By repeatedly executing this line segment detection process on the multiple chronological images, detected line segments are accumulated for regions A₁ to A_{M}.

The line segments detected by the line segment detection algorithm may include line segments corresponding to straight lines extending in various directions in a three-dimensional space. Thus, the detector 512 may determine, based on the linearity, length, inclination, edge intensity, and the like of each of the line segments, whether or not each of the line segments corresponds to a vertical straight line, and the detector 512 may record only a line segment corresponding to the vertical straight line as a candidate line segment 532.

The checker 521 of the estimator 513 selects, from among line segments included in the candidate line segments 532, a line segment existing in a central region including the center of an image and checks whether or not the number of selected line segments is equal to or larger than a predetermined number N. For example, a line segment associated with a region A_{(M+1)/2} among the regions A₁ to A_{M} illustrated in FIG. 6 is selected as a line segment existing in the central region. In this case, the checker 521 selects not only a line segment detected from an image captured at the current time but also line segments detected from images captured at multiple time points within a time period from past time to the current time.

When the number of line segments existing in the central region is equal to or larger than the predetermined number N, the orientation estimator 522 executes a statistical process on the inclinations of the line segments and calculates an estimated value of a representative inclination. Then, the orientation estimator 522 estimates the roll angle r of the imaging device 501 using the calculated estimated value and a focal length of the imaging device 501 and causes orientation information 533 indicating the estimated roll angle r to be stored in the storage unit 511.

Most of multiple straight lines that are stably observed at the periphery of a road surface on which the vehicle moves may be treated as a vertical straight line extending in a direction perpendicular to the road surface. The orientation estimator 522 may calculate the roll angle r by executing the statistical process on a line segment existing in a central region, calculating, for example, the most frequent inclination as an estimated value of a representative inclination, and substituting the estimated value into the inclination T expressed by Equation (36).

To stably calculate the estimated value of the representative inclination, it is desirable that the largest possible value be set as the predetermined number N. For example, N may be an integer in a range of several hundreds to several thousands. As the statistical process to be executed on inclinations of line segments, a voting process may be used, for example. In addition, when a line segment that does not correspond to a vertical straight line is excluded from the candidate line segments 532, an arithmetic process of calculating an average value, a median, or the like may be used as the statistical process.

The orientation estimator 522 may use the estimated roll angle r to further estimate a pitch angle p and yaw angle y of the imaging device 501 and generate orientation information 533 indicating the roll angle r, the pitch angle p, and the yaw angle y.

The processing unit 514 uses the orientation information 533 to execute image processing on the video image 531. The image processing to be executed on the video image 531 may be a process of detecting a white line, a pedestrian, and the like. The processing unit 514 may control LDW or the vehicle based on results of the image processing.

The estimation system illustrated in FIG. 5 may extract, from the video image 531 captured during a movement of the vehicle, a line segment unaffected by the pitch angle p and estimate the roll angle r with high accuracy even when the roll angle r and pitch angle p of the imaging device 501 exist.

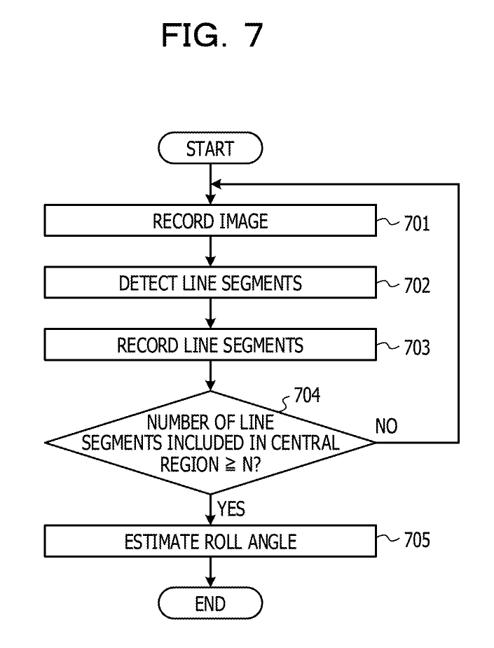

FIG. 7 is a flowchart of an example of a first estimation process to be executed by the estimating device 502 illustrated in FIG. 5. First, the estimating device 502 records, in the video image 531, an image captured by the imaging device 501 at a time point and output by the imaging device 501 (in step 701). Then, the detector 512 detects line segments from the recorded image (in step 702), associates the detected line segments with regions Aᵢ to which the detected line segments belong, and records the line segments as candidate line segments 532 (in step 703).

Then, the checker 521 compares the number of line segments that exist in a central region of the image and are among line segments included in the candidate line segments 532 with the predetermined number N (in step 704). When the number of line segments existing in the central region is smaller than the predetermined number N (NO in step 704), the estimating device 502 repeatedly executes the processes of steps 701 and later on an image captured at the next time point.

On the other hand, when the number of line segments existing in the central region is equal to or larger than the predetermined number N (YES in step 704), the orientation estimator 522 uses the inclinations of the line segments to estimate the roll angle r of the imaging device 501 and generates orientation information 533 indicating the estimated roll angle r (in step 705).

Since a vertical straight line is rarely observed in a central region of an image during a normal movement of the vehicle, it is difficult to detect a number N of line segments existing in the central region within a predetermined time period.

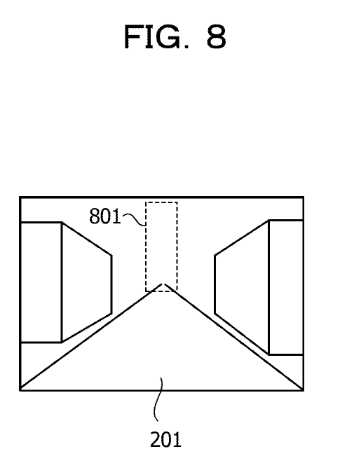

FIG. 8 illustrates an example of an image that does not include a line segment in a central portion of the image. The image illustrate in FIG. 8 corresponds to the image illustrated in FIG. 2. In a central portion 801 of the image illustrated in FIG. 8, a line segment corresponding to a vertical straight line does not exist. It is difficult to extract a line segment unaffected by the pitch angle p from a video image including such chronologically continuous images and estimate the roll angle r. A video image captured during a normal movement of the vehicle, however, has the following characteristics (C1) and (C2).

(C1) Vertical straight lines may be stably observed in edge regions located closer to left and right edge portions of an image than a central region of the image in a horizontal direction.

(C2) Although the inclinations of certain line segments corresponding to vertical straight lines observed in edge regions of an image vary depending on the positions of the line segments within the image, the inclination of a line segment corresponding to a virtual vertical straight line that may be observed in a central region of the image may be estimated using the certain line segments.

In the embodiment described below, attention is paid to these characteristics, vertical straight lines observed on the left and right sides of a central region of an image are used to estimate the inclination of a line segment corresponding to a vertical straight line assumed to exist in the central region and estimate the roll angle r from the estimated inclination. Thus, even when the number of detected line segments existing in the central region is smaller than the predetermined number N, the roll angle r may be estimated with high accuracy.

In a state in which the vehicle normally moves, vertically long objects that extend from a road surface in a vertical direction and are buildings, telephone poles, and the like exist on the left and right sides of the road surface. Objects that are included in a video image captured in a movement direction (forward direction) of the vehicle and are buildings, telephone poles, and the like move from central regions of images toward edge portions of the images and become larger as the vehicle is closer to the objects. The outlines of the objects included in the video image are clearer as the objects are closer to the edge portions of the images. Thus, it is considered that a video image having the aforementioned characteristic (C1) is captured.

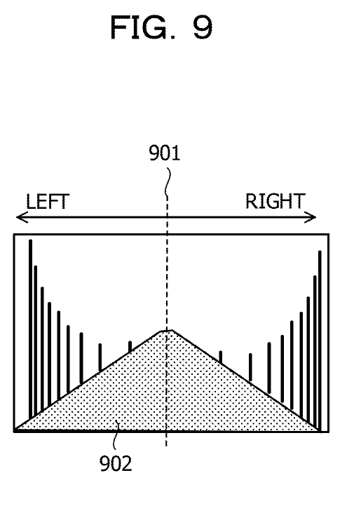

FIG. 9 illustrates an example of an image including a large number of line segments in each of edge portions of the image. A road surface 902 included in the image illustrated in FIG. 9 is formed in a bilaterally symmetric shape with respect to a central line 901 of the image. The numbers of detected line segments located at left and right edges of the road surface 902 are larger toward left and right edges of the image from the central line 901. These line segments correspond to vertical straight lines indicating outlines of vertically long objects such as buildings and telephone poles.

In addition, relationships between the positions and inclinations of line segments corresponding to vertical straight lines within the images may be modeled using the aforementioned characteristic (C2). By executing this, the inclination of a vertical straight line when the vertical straight line is assumed to have been observed in a central region in which it is actually difficult to observe the vertical straight line may be estimated.

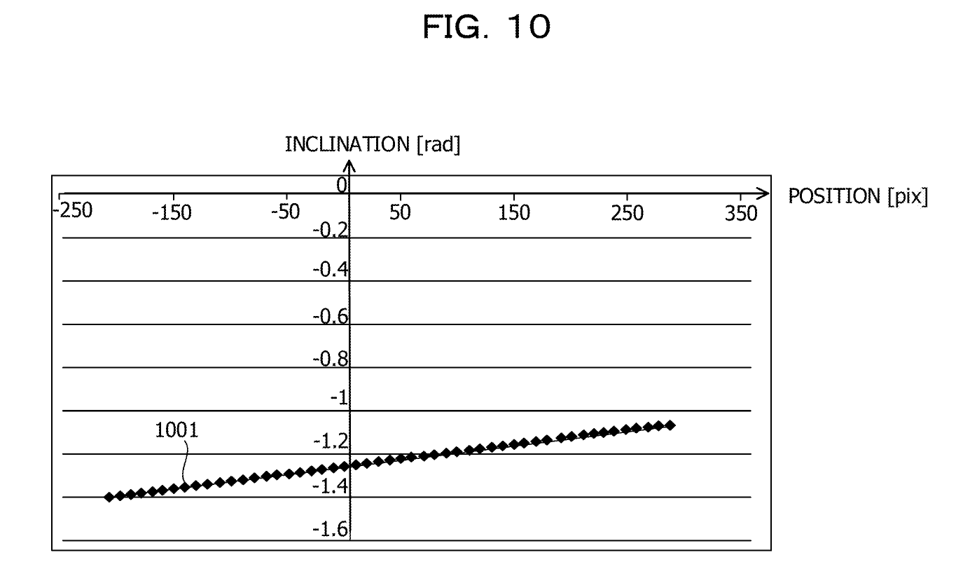

FIG. 10 illustrates an example of relationships between the positions and inclinations of line segments within an image. In FIG. 10, the abscissa indicates a position expressed in units of pixels in a horizontal direction in an image, the original point corresponds to a central line of the image in the horizontal direction, and the ordinate indicates a value obtained by converting the inclination of a line segment corresponding to a vertical straight line to an angle expressed in radians.

For example, it is assumed that, in the world coordinate system illustrated in FIG. 4, a certain line segment that is separated by a distance of 10000 from the original point in the Z axis direction and is parallel to the X axis exists. When inclinations T of multiple vertical straight lines extending from the certain line segment and located at intervals of 200 in an X coordinate range of −5000 to 5000 are calculated using Equations (11) to (21), a graph 1001 is obtained. In this case, each of the inclinations T is calculated as an equation of fx=fy. As is apparent from the graph 1001, the inclinations of the vertical straight lines observed on a road surface smoothly vary based on the positions of the vertical straight lines within the image, the relationships between the positions and inclinations of the line segments may be modeled.

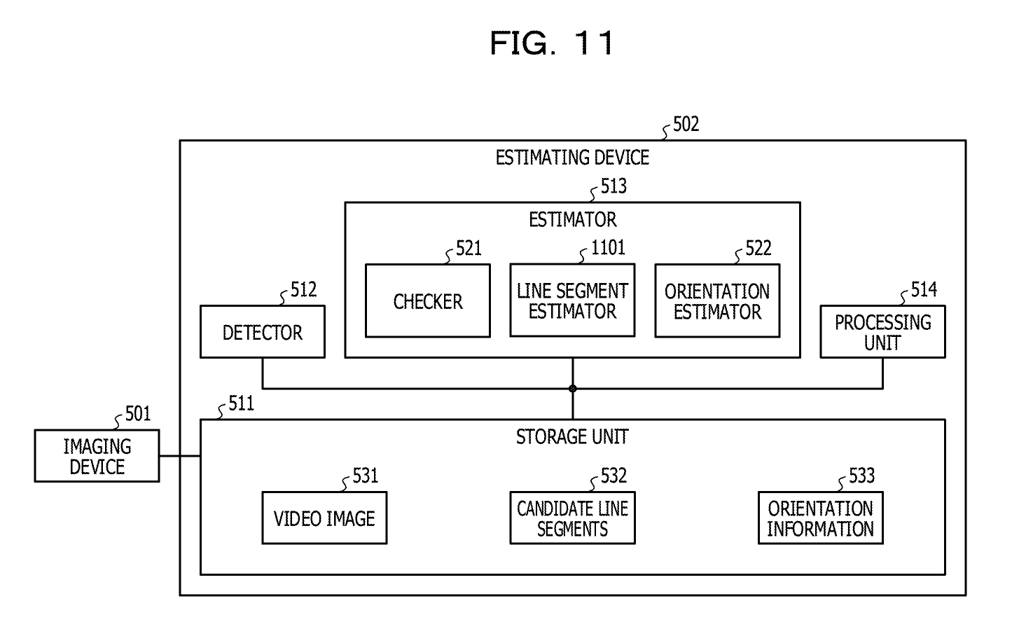

FIG. 11 illustrates an example of a functional configuration of a second estimation system configured to estimate the roll angle r using vertical straight lines observed on the left and right sides of a central region of an image. An estimation system illustrated in FIG. 11 includes the configuration of the estimation system illustrated in FIG. 5 and a line segment estimator 1101 in the estimator 513.

When the number of line segments existing in a central region of an image is smaller than the predetermined number N, the checker 521 of the estimator 513 selects, from among line segments included in candidate line segments 532, a line segment existing in a left edge region close to a left edge of the image and a line segment existing in a right edge region close to a right edge of the image.

For example, when the image is divided into multiple regions as illustrated in FIG. 6, a number K (K is an integer of one or more) of regions (A₁ to Aₖ) from the left edge of the image are selected as left edge regions, and a number K of regions (A_{M-K+1} to A_{M}) from the right edge of the image are selected as right edge regions. In this case, the checker 521 selects line segments existing in the regions Aᵢ (i=1 to K and M−K+1 to M) and checks whether or not the number of selected line segments is equal to or larger than a predetermined number Nᵢ set for the regions Aᵢ.

As illustrated in FIG. 9, in a state in which the vehicle normally moves, the numbers of detected line segments are larger toward left and right edges of the image from the central region of the image. Thus, it is preferable that the predetermined number Nᵢ be set to be smallest for the central region A_{(M+1)/2} and to be larger toward the left and right edges and to be largest for the regions A₁ and A_{M}. In this case, the following equations are established.

N₁≥N₂≥ . . . ≥N_{(M+1)/2}≤ . . . N_{M-1}≤N_{M} (41)

N_{(M+1)/2} included in Equations (41) corresponds to the predetermined number N set for the central region A_{(M+1)/2} in the estimation system illustrated in FIG. 5. In the case where the predetermined number Nᵢ is used, the number of secured line segments is larger toward an edge of the image in each of the left and right edge regions.

When the number of line segments is equal to or larger than the predetermined number Nᵢ in each of multiple regions Aᵢ included in each of the left and right edge regions, the line segment estimator 1101 uses the inclinations of the line segments to calculate an estimated value of a representative inclination of a line segment existing in the central region. The estimated value indicates an inclination T of a vertical straight line when the vertical straight line is assumed to have been observed in the central region. When the number of line segments existing in a region Aᵢ included in the left edge region or the right edge region is smaller than the predetermined number Nᵢ, a line segment included in the region Aᵢ is not used to calculate the estimated value.

For example, the line segment estimator 1101 executes a statistical process on inclinations of line segments existing in each of the regions Aᵢ, thereby calculating estimated values indicating representative inclinations in the regions Aᵢ. Then, the line segment estimator 1101 generates a model indicating relationships between positions x of the regions Aᵢ in the horizontal direction and the estimated values t of the inclinations in the regions Aᵢ and uses the generated model to calculate an estimated value of a representative inclination in the central region. As the model, a straight-line equation of t=ax+b, a curve equation of t=ax³+bx²+cx+d, or the like may be used. a, b, c, and d are fixed numbers.

In addition, the line segment estimator 1101 may use the inclinations of all line segments existing in the regions Aᵢ, instead of estimated values of the inclinations of the line segments existing in the regions Aᵢ, to generate a model indicating relationships between the positions x and inclinations t of the line segments.

The orientation estimator 522 uses the estimated value calculated by the line segment estimator 1101 and indicating the representative inclination in the central region and the focal length of the imaging device 501 to estimate the roll angle r of the imaging device 501 and generates orientation information 533 indicating the roll angle r.

Even when a number N of line segments are not detected from a central region of an image, the estimation system illustrated in FIG. 11 may use line segments detected from left and right edge regions of the image to estimate the roll angle r with high accuracy.

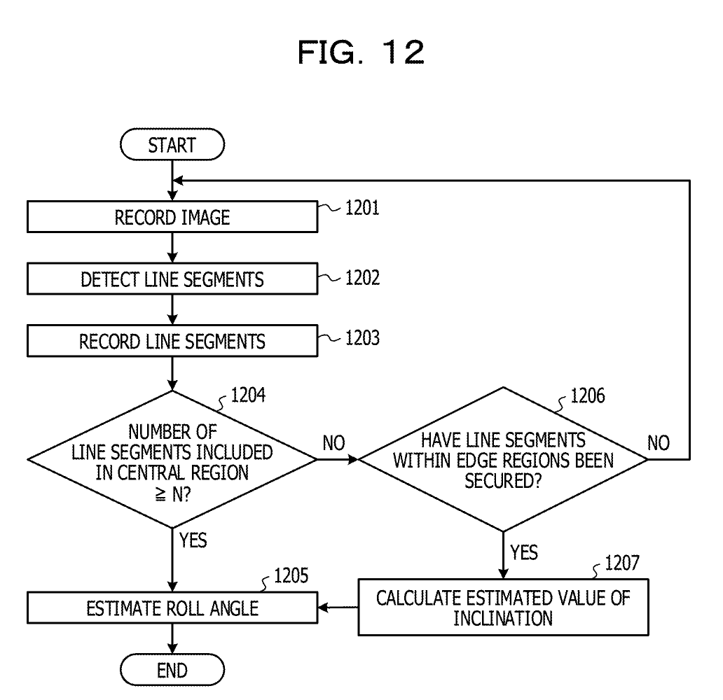

FIG. 12 is a flowchart of an example of a second estimation process to be executed by the estimating device 502 illustrated in FIG. 11. Processes of steps 1201 to 1204 illustrated in FIG. 12 are the same as or similar to the processes of steps 701 to 704 illustrated in FIG. 7. A number N that is used in step 1204 corresponds to N_{(M+1)/2} included in Equations (41).

When the number of line segments existing in a central region of an image is equal to or larger than N (YES in step 1204), the orientation estimator 522 uses the inclinations of the line segments to estimate the roll angle r of the imaging device 501 and generates orientation information 533 indicating the roll angle r (in step 1205).

On the other hand, when the number of line segments existing in the central region is smaller than N (NO in step 1204), the checker 521 checks whether or not line segments within edge regions of the image have been secured (in step 1206). In this case, the checker 521 compares the number of line segments within each of regions Aᵢ included in left and right edge regions of the image with the predetermined number Nᵢ. The checker 521 determines that the line segments within the edge regions are secured when the number of line segments within each of the multiple regions Aᵢ is equal to or larger than the predetermined number Nᵢ. When the number of line segments within any of the regions Aᵢ is smaller than predetermined number Nᵢ, the checker 521 determines that the line segments within the edge regions are not secured.

When the line segments within the edge regions are not secured (NO in step 1206), the estimating device 502 repeatedly executes the processes of steps 1201 and later on an image captured at the next time point.

On the other hand, when the line segments within the edge regions are secured (YES in step 1206), the line segment estimator 1101 uses the inclinations of the line segments to calculate an estimated value of a representative inclination in the central region (in step 1207). Then, the orientation estimator 522 uses the estimated value calculated by the line segment estimator 1101 to estimate the roll angle r of the imaging device 501 and generates orientation information indicating the roll angle r (in step 1205).

The configurations of the estimation systems illustrated in FIGS. 5 and 11 are examples, and one or more constituent elements of the estimation systems illustrated in FIGS. 5 and 11 may be omitted or changed based on the use or conditions of the estimation systems. For example, the imaging device 501 and the estimating device 502 may be attached to another movable object such as a movable robot, instead of being attached to the vehicle. When an external device of the estimating device 502 executes image processing on the video image 531, the processing unit 514 of the estimating device 502 may be omitted.

The estimating device 502 may be a server installed outside the vehicle. In this case, the imaging device 501 attached to the vehicle transmits the video image 531 to the estimating device 502 via the communication network, and the estimating device 502 controls LDW or the vehicle via the communication network. In addition, the estimating device 502 may use results of executing the image processing on the video image 531 as a learning material for a driver.

The storage unit 511, the detector 512, the estimator 513, and the processing unit 514 may be distributed and implemented in multiple devices, instead of being implemented in the single device.

The flowcharts illustrated in FIGS. 7 and 12 are examples, and one or more processes included in the flowcharts may be omitted or changed based on the configurations or conditions of the estimation systems. For example, the detector 512 may detect line segments from an image captured at a certain time point within a predetermined time period, instead of detecting line segments from the images captured at all the time points and included in the video image 531.

The position of the attached imaging device 102 illustrated in FIG. 1 is an example, and the imaging device 102 may be attached to an upper surface, side surface, bottom surface, or the like of the vehicle 101. The images illustrated in FIGS. 2, 3, 8, and 9 are examples. The captured images and the line segments detected from the images may vary depending on a state in which the vehicle moves. The world coordinate system and the camera coordinate system that are illustrated in FIG. 4 are examples, and another coordinate system may be used.

The method of dividing images that is described with reference to FIG. 6 is an example, and the images may be divided using another division method. The graph illustrated in FIG. 10 is an example, and another model indicating the positions and inclinations of line segments within an image may be used. Equations (1) to (36) are examples, and an inclination T of a vertical straight line within an image may be calculated according to other equations. Equations (41) are examples, and the predetermined number N, of line segments within a region Aᵢ may be set according to another method.

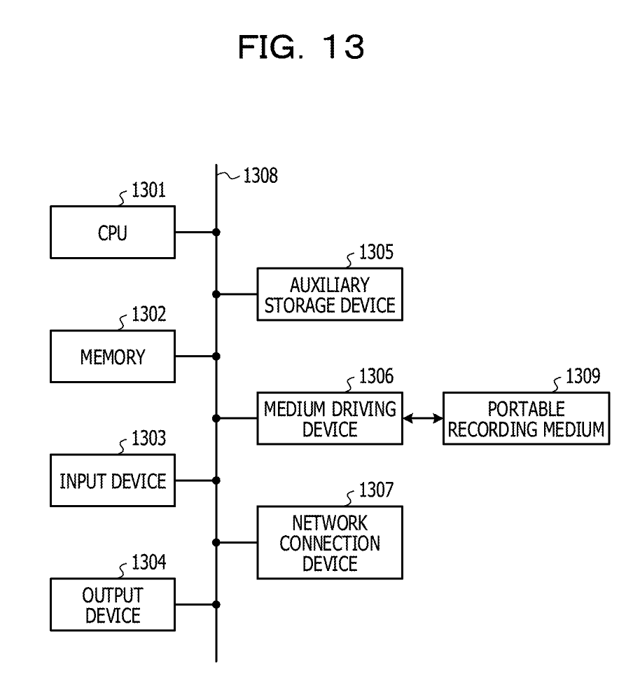

FIG. 13 illustrates an example of a configuration of an information processing device (computer) used as the estimating device 502 illustrated in FIGS. 5 and 11. The information processing device illustrated in FIG. 13 includes a central processing unit (CPU) 1301, a memory 1302, an input device 1303, an output device 1304, an auxiliary storage device 1305, a medium driving device 1306, and a network connection device 1307. These constituent elements 1301 to 1307 are connected to each other via a bus 1308.

The memory 1302 is, for example, a semiconductor memory such as a read only memory (ROM), a random access memory (RAM), or a flash memory and stores a program and data that are used for the processes. The memory 1302 may be used as the storage unit 511 illustrated in FIGS. 5 and 11.

The CPU 1301 (processor) executes the program using the memory 1302, thereby operating as the detector 512, the estimator 513, the processing unit 514, the checker 521, and the orientation estimator 522, which are illustrated in FIGS. 5 and 11. The CPU 1301 executes the program using the memory 1302, thereby operating as the line segment estimator 1101 illustrated in FIG. 11.

The input device 1303 is, for example, a keyboard, a pointing device, or the like and is used to input an instruction and information from an operator or a user. The output device 1304 is, for example, a display device, a printer, a speaker, or the like and is used to output an inquiry or an instruction and a process result to the operator or the user. The process result may be the orientation information 533, results of executing the image processing on the video image 531, or an alarm for the driver.

The auxiliary storage device 1305 is, for example, a magnetic disk device, an optical disc device, a magneto-optical disc device, a tape device, or the like. The auxiliary storage device 1305 may be a hard disk drive or a flash memory. The information processing device may cause the program and the data to be stored in the auxiliary storage device 1305, load the program and the data into the memory 1302, and use the program and the data. The auxiliary storage device 1305 may be used as the storage unit 511 illustrated in FIGS. 5 and 11.

The medium driving device 1306 drives a portable recording medium 1309 and accesses details recorded in the portable recording medium 1309. The portable recording medium 1309 is a memory device, a flexible disk, an optical disc, a magneto-optical disc, or the like. The portable recording medium 1309 may be a compact disc read only memory (CD-ROM), a digital versatile disc (DVD), a Universal Serial Bus (USB) memory, or the like. The operator or the user may cause the program and the data to be stored in the portable recording medium 1309, load the program and the data into the memory 1302, and use the program and the data.

A computer-readable recording medium storing the program and the data that are used for the processes is a physical (non-transitory) recording medium such as the memory 1302, the auxiliary storage device 1305, or the portable recording medium 1309.

The network connection device 1307 is a communication interface circuit connected to a communication network such as a local area network or a wide area network and configured to execute data conversion for communication. The information processing device may receive the program and the data from an external device via the network connection device 1307, load the program and the data into the memory 1302, and use the program and the data.

The information processing device may not include all the constituent elements illustrated in FIG. 13, and one or more of the constituent elements may not be omitted based on the use or conditions of the information processing device. For example, when the information processing device interacts with the operator or the user, the input device 1303 and the output device 1304 may be omitted. In addition, when the portable recording medium 1309 or the communication network is not used, the medium driving device 1306 or the network connection device 1307 may be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for estimating orientation, comprising:
executing a detection process that includes detecting multiple line segments from each of multiple images included in a video image captured by an imaging device;
executing an estimation process that includes
estimating a first inclination that is an inclination of a line segment that is among the multiple line segments and detected from a central region including a center of an image among the multiple images; and
associating the first inclination with a vertical direction in a three-dimensional space to estimate an orientation of the imaging device.

2. The method according to claim 1,
wherein the estimation process is configured to
calculate the first inclination by executing a statistical process on second inclinations that are inclinations of multiple line segments detected from the central region, and
use the first inclination and a focal length of the imaging device to calculate a roll angle of the imaging device, when the number of line segments that are among the multiple line segments and detected from the central region is larger than a predetermined number.

3. The method for according to claim 1,
wherein the estimation process is configured to
calculate the first inclination by using a third inclination that is the inclination of a line segment detected from a first edge region closer to one of edge portions of the image than the central region in a horizontal direction and a fourth inclination that is the inclination of a line segment detected from a second edge region closer to the other of the edge portions of the image than the central region in the horizontal direction, and
use the first inclination and a focal length of the imaging device to calculate a roll angle of the imaging device, when the number of line segments that are among the multiple line segments and detected from the central region is smaller than a predetermined number.

4. The method according to claim 3,
wherein the estimation process is configured to
select line segments from each of multiple first regions into which the first edge region is divided in the horizontal direction so that the number of line segments selected from each of the first regions is larger as the first region is closer to the one of the edge portions,
select line segments from each of multiple second regions into which the second edge region is divided in the horizontal direction so that the number of line segments selected from each of the second regions is larger as the second region is closer to the other of the edge portions, and
calculate the first inclination by using the inclinations of the line segments selected from the first edge region and the inclinations of the line segments selected from the second edge region.

5. A apparatus for estimating orientation, comprising:
a memory; and
processor circuitry coupled to the memory, the processor circuitry being configured to
execute a detection process that includes detecting multiple line segments from each of multiple images included in a video image captured by an imaging device;
execute an estimation process that includes
estimating a first inclination that is an inclination of a line segment that is among the multiple line segments and detected from a central region including a center of an image among the multiple images; and
associating the first inclination with a vertical direction in a three-dimensional space to estimate an orientation of the imaging device.

6. The apparatus according to claim 5,
wherein the estimation process is configured to
calculate the first inclination by executing a statistical process on second inclinations that are inclinations of multiple line segments detected from the central region, and
use the first inclination and a focal length of the imaging device to calculate a roll angle of the imaging device, when the number of line segments that are among the multiple line segments and detected from the central region is larger than a predetermined number.

7. The apparatus according to claim 5,
wherein the estimation process is configured to
calculate the first inclination by using a third inclination that is the inclination of a line segment detected from a first edge region closer to one of edge portions of the image than the central region in a horizontal direction and a fourth inclination that is the inclination of a line segment detected from a second edge region closer to the other of the edge portions of the image than the central region in the horizontal direction, and
use the first inclination and a focal length of the imaging device to calculate a roll angle of the imaging device, when the number of line segments that are among the multiple line segments and detected from the central region is smaller than a predetermined number.

8. The apparatus according to claim 7,
wherein the estimation process is configured to
select line segments from each of multiple first regions into which the first edge region is divided in the horizontal direction so that the number of line segments selected from each of the first regions is larger as the first region is closer to the one of the edge portions,
select line segments from each of multiple second regions into which the second edge region is divided in the horizontal direction so that the number of line segments selected from each of the second regions is larger as the second region is closer to the other of the edge portions, and
calculate the first inclination by using the inclinations of the line segments selected from the first edge region and the inclinations of the line segments selected from the second edge region.

9. A non-transitory computer-readable storage medium for storing a program that causes a processor to execute a process for estimating orientation, the process comprising:
executing a detection process that includes detecting multiple line segments from each of multiple images included in a video image captured by an imaging device;
executing an estimation process that includes
estimating a first inclination that is an inclination of a line segment that is among the multiple line segments and detected from a central region including a center of an image among the multiple images; and
associating the first inclination with a vertical direction in a three-dimensional space to estimate an orientation of the imaging device.

10. The non-transitory computer-readable storage medium according to claim 9,
wherein the estimation process is configured to
calculate the first inclination by executing a statistical process on second inclinations that are inclinations of multiple line segments detected from the central region, and
use the first inclination and a focal length of the imaging device to calculate a roll angle of the imaging device, when the number of line segments that are among the multiple line segments and detected from the central region is larger than a predetermined number.

11. The non-transitory computer-readable storage medium for according to claim 9,
wherein the estimation process is configured to
calculate the first inclination by using a third inclination that is the inclination of a line segment detected from a first edge region closer to one of edge portions of the image than the central region in a horizontal direction and a fourth inclination that is the inclination of a line segment detected from a second edge region closer to the other of the edge portions of the image than the central region in the horizontal direction, and
use the first inclination and a focal length of the imaging device to calculate a roll angle of the imaging device, when the number of line segments that are among the multiple line segments and detected from the central region is smaller than a predetermined number.

12. The non-transitory computer-readable storage medium according to claim 11,
wherein the estimation process is configured to
select line segments from each of multiple first regions into which the first edge region is divided in the horizontal direction so that the number of line segments selected from each of the first regions is larger as the first region is closer to the one of the edge portions,
select line segments from each of multiple second regions into which the second edge region is divided in the horizontal direction so that the number of line segments selected from each of the second regions is larger as the second region is closer to the other of the edge portions, and
calculate the first inclination by using the inclinations of the line segments selected from the first edge region and the inclinations of the line segments selected from the second edge region.
